(19) United States
(12) Patent Application Publication
(10) Pub. No.: US 2026/0085676 A1
(43) Pub. Date: Mar. 26, 2026

(54) Pump Assembly with Hydraulic System Cooling

(71) Applicant: EXEL INDUSTRIES, Epernay (FR)

(72) Inventors: Nicolas Plantard, Epernay (FR); Boussif Khaldi, Epernay (FR); Wayne Snodin, Epernay (FR)

(21) Appl. No.: 19/331,674

(22) Filed: Sep. 17, 2025

(30) Foreign Application Priority Data
Sep. 20, 2024 (FR) 2410055

(51) Int. Cl. F04B 43/06; F15B 15/14

(52) U.S. Cl. CPC F04B 43/06; F15B 15/1447

(57) ABSTRACT

The present invention relates to a pump assembly, more particularly for a coating fluid, comprising a motor and hydraulics, the motor comprising an air inlet, the hydraulics comprising at least one pumping system, the motor being able to drive the at least one pumping system by means of a hydraulic system, characterized in that the pump assembly comprises at least one air passage arranged so as to allow thermal exchanges between the hydraulic system and the at least one air passage, the at least one air passage being able to be supplied with air by an air source, the at least one air passage being fluidly connected opposite the air source to the air inlet of the motor.

### CROSS-REFERENCE TO RELATED APPLICATIONS

This application claims priority to French Application No. 2410055, filed on Sep. 20, 2024, which is incorporated herein by reference in their entireties.

### BACKGROUND OF THE INVENTION

The present invention relates to a pump assembly, more particularly for a coating fluid, comprising a motor, a piston, and a pump, the piston being arranged to be driven by the motor and thus drive the pump by means of a hydraulic system.

The motor is, for example, an air motor, the pump is a diaphragm pump, for example with two diaphragms, and the hydraulic system corresponds to a drive system with oil.

The motor operates at speeds of up to 300 cycles per minute, for example. This causes heating of the hydraulic system on one hand, which is likely to change the viscosity within the hydraulic system, here oil, and cooling of the motor on the other hand, which may lead to frost formation on the motor.

The document DE 103 18 004 B describes the addition of a practically closed envelope surrounding the pump. The exhaust air from the motor is evacuated into the envelope to cool the pump.

The system is provided with an adjustable flap to redirect part of the exhaust air toward the outside.

However, the exhaust air from the motor is likely to vary, so this would require constant adjustment, especially with the adjustable flap.

Furthermore, the adjustable flap only allows to reduce the amount of exhaust air received for cooling, and therefore to reduce the cooling effect.

There is no adjustment system in the case where the cooling is not sufficient.

Finally, this does not prevent frost formation on the motor.

The purpose of the invention is then to propose a pump assembly with a hydraulic system cooling, not varying according to the operation of the pump assembly, and motor heating.

### SUMMARY OF THE INVENTION

To this end, the invention has as its object a pump assembly, more particularly for a coating fluid, comprising a motor and hydraulic, the motor comprising an air inlet, the hydraulics comprising at least one pumping system, the motor being able to drive the at least one pumping system by means of a hydraulic system, characterized in that the pump assembly comprises at least one air passage arranged so as to allow thermal exchanges between the hydraulic system and the at least one air passage, the at least one air passage being able to be supplied with air by an air source, the at least one air passage being fluidly connected opposite the air source to the air inlet of the motor.

The air supplied by the air source does not vary as a function of the motor exhaust. The air cools the hydraulic system, is heated by said hydraulic system, and then supplies the motor, so as to heat the motor. Finally, the cooling of the hydraulic system and the heating of the motor are adapted to the use of the pump.

According to other advantageous aspects of the invention, the pump assembly comprises one or more of the following features, taken alone or in any technically possible combination:
the air source is a compressed air source, more particularly compressed air from a compressor;
the pump assembly is a diaphragm pump, the hydraulic system extending here between a piston of the hydraulic system and the or each diaphragm, the hydraulic system being preferably filled with oil;
the assembly comprises a pump body, in which the at least one air passage is directly delimited in the pump body;
the hydraulic system comprises at least one conduit portion, for example filled with oil, the conduit portion extending more particularly between a piston of the hydraulics and at least one diaphragm of the pump;
the at least one air passage comprises a respective air passage ring extending around the or each conduit portion;
the or each ring presents an internal wall and an external wall, the air circulating between the internal wall and the external wall, the internal wall and/or the external wall being corrugated;
the or each ring comprises an inlet and an outlet, the inlet and the outlet of the or each ring being diametrically opposed to each other;
the or each ring comprises an inlet and an outlet, the inlet and the outlet of the or each ring being offset according to a direction parallel to the central axis of the ring;
the assembly comprises two air passages, each air passage presenting an inlet and an outlet, the inlet of a first of the air passages being able to be fluidly connected to the air source, so that the air source supplies the first of the air passages, the outlet of the first of the air passages being connected to the inlet of the second of the air passages, the outlet of the second of the air passages being connected to the air inlet of the motor; and
the assembly comprises two air passages, each air passage presenting an inlet and an outlet, the inlets of the two air passages being able to be fluidly connected to the air source, so that the air source supplies the air passages, the outlets of the air passages being connected to the air inlet of the motor.

### BRIEF DESCRIPTION OF THE DRAWINGS

The invention will become clearer upon reading the following description, given solely by way of non-limiting example, and made with reference to the following drawings.

FIG. 1 is a sectional view of a pump assembly, according to one example embodiment of the invention.

FIG. 2 is a sectional view according to plane II of the pump assembly of FIG. 1.

FIG. 3 is a sectional view according to plane III of the pump assembly of FIG. 1.

FIG. 4 is a schematic representation of the air circulation in a pump assembly in a first alternative of the invention.

FIG. 5 is a schematic representation of the air circulation in a pump assembly in a second alternative of the invention.

### DETAILED DESCRIPTION OF THE INVENTION

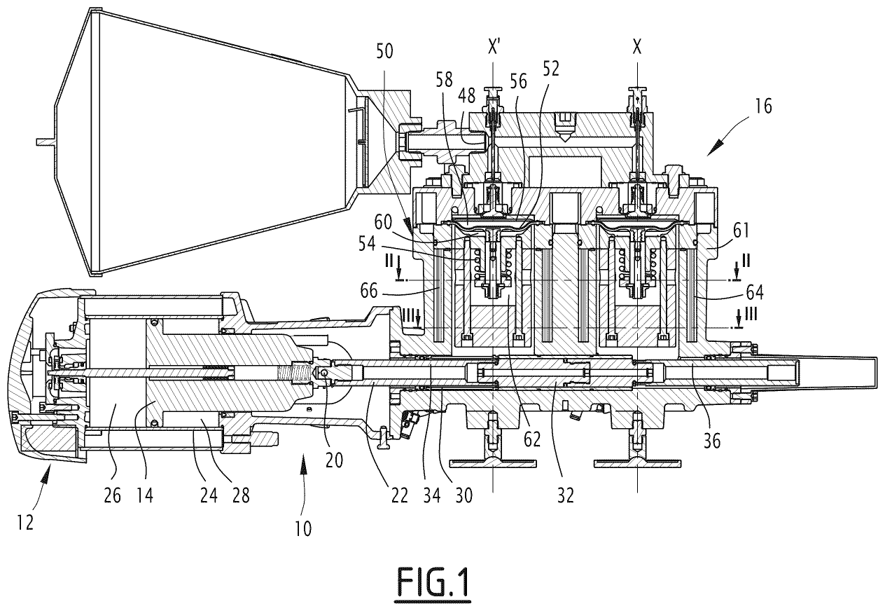

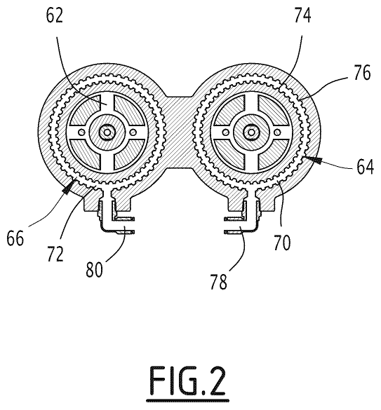

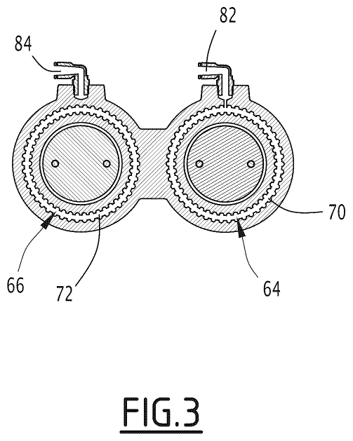

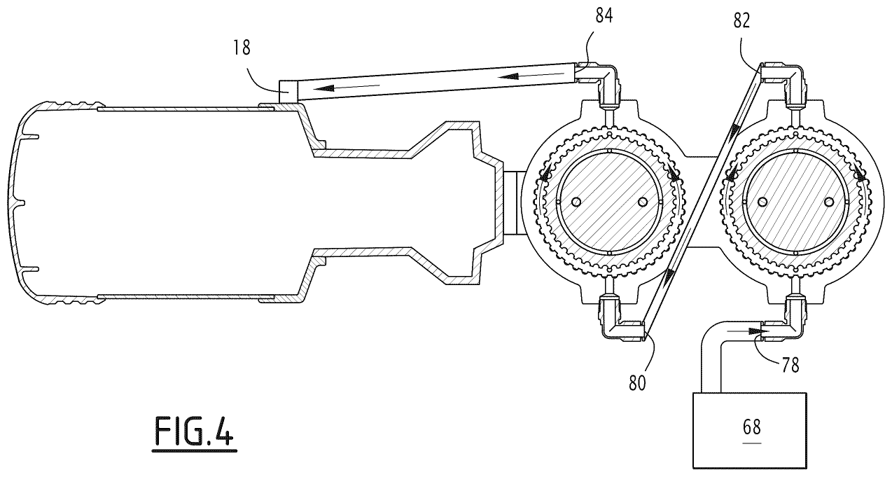

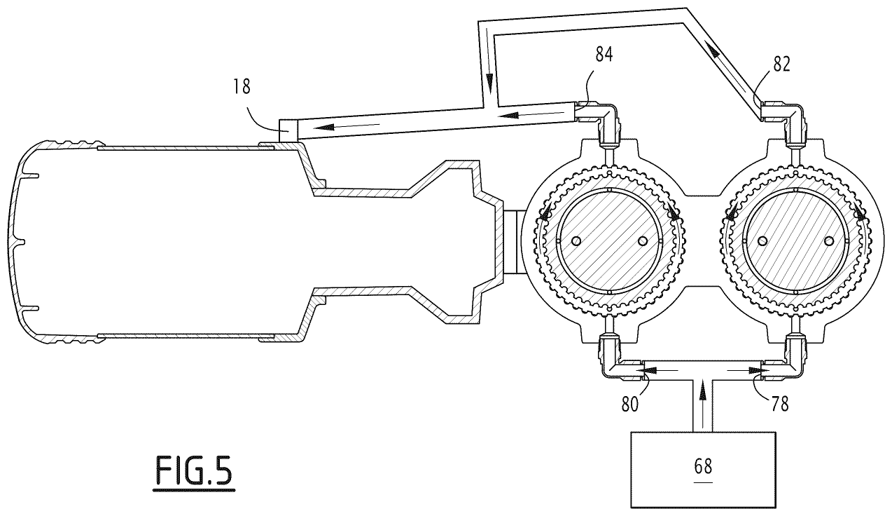

A pump assembly 10 according to one example embodiment of the invention is represented in FIGS. 1 to 3, except for certain connections which will be detailed later with reference to FIGS. 4 and 5.

The pump assembly 10 is intended for a coating fluid, for example paint.

The pump assembly 10 comprises a motor 12 and hydraulics 16.

The motor 12 is, for example, an air motor, more particularly compressed air.

The motor 12 comprises an air inlet 18, represented in FIGS. 4 and 5.

The motor is, for example, able to operate at up to 300 cycles per minute.

The motor 12 presents an exhaust outlet (not represented), the exhaust outlet opening into the external environment, particularly away from the pump 16 or the air passage described below.

The motor 12 is able to drive the displacement of a motor piston 14, comprised in the motor 12, more particularly in translation.

The piston 14 is arranged in a cylinder 24, so as to delimit a first chamber 26 and a second chamber 28 in the cylinder 24.

The first chamber 26 extends on the side of the motor, while the second chamber 28 extends on the side of the pump 16.

Each chamber 26, 28 is alternately supplied with air, here compressed air, by the motor 12, so as to cyclically displace the motor piston 14 in translation in the cylinder 24, more particularly between a first position in which the volume of the first chamber 26 is minimal and a second position in which the volume of the first chamber 26 is maximal.

The hydraulics 16 comprises a hydraulic piston 22.

The hydraulic piston 22 is connected to the motor piston 14, here via a pin 20.

This allows to separate the motor 12 and the hydraulics 16, for maintenance, for example.

The hydraulic piston 22 is able to displace jointly with the motor piston 14, here in translation according to the same direction.

The hydraulic piston 22 extends from the piston 14 opposite the first chamber 26.

The hydraulic piston 22 extends facing the at least one pumping system of the pump, in a body, here the pump body, described below.

The body presents a bore 30 provided to receive the hydraulic piston 22 opposite the motor piston 14.

The hydraulic piston 22 here comprises a central section 32 and at least one lateral section 34, 36 adjacent to the central section 32, here two lateral sections 34, 36 on either side of the central section 32.

The central section 32 is, for example, here made in two interdependent pieces.

The central section 32 presents an outer diameter strictly greater than the outer diameter of the or each lateral section 34.

This acts as a pressure multiplier.

The hydraulic piston 22 is here constituted of the pin 20, the central section 32, and the two lateral sections 34, 36.

The hydraulics 16 presents a fluid product inlet 48, here in coating product, the pump 10 being able to pump said fluid product.

The hydraulics 16 comprises at least one pumping system 50, here two pumping systems.

The pump 10 is a diaphragm pump.

More particularly, each pumping system 50 comprises a diaphragm 52.

Each pumping system comprises a housing 56 in which the diaphragm 52 is arranged. The housing 56 is separated by the diaphragm 52 into a product volume 58 and a drive volume 60.

The product volume 58 and the drive volume 60 do not fluidly communicate.

The product volume 58 is supplied with fluid product by the inlet 48 and presents an outlet.

Any displacement of the diaphragm 52 increasing the volume of the product volume 58 leads to suction of the fluid product into the product volume 58 by means of the inlet 48, and any displacement of the diaphragm 52 decreasing the volume of the product volume 58 leads to discharge of fluid product at the outlet of the product volume 58.

Each pumping system 50 further comprises a return element 54, here a spring, returning the diaphragm 52 to a rest position, corresponding to the position in which the product volume 58 presents an intermediate volume.

A reception volume 62 fluidly connects the drive volume 60 to the bore 30.

The reception volume 62 extends here perpendicularly to the rod 22.

The return element 54 is arranged in the reception volume 62.

Furthermore, here, the pump 10 comprises a pump body 61.

The pump body 61 here delimits the reception volume 62.

When the motor piston 14 is in the first position, the central section 32 extends facing a pumping system of the pump, called first pumping system, more particularly in view of the reception volume 62 of said pumping system.

Facing the second pumping system, a lateral section 34 extends, when the motor piston 14 is in the first position.

When the motor piston 14 is in the second position, a lateral section 34 extends facing the first pumping system.

When the motor piston 14 is in the second position, the central section 32 extends facing the second pumping system.

The displacement of the motor piston 14 between the first position and the second position therefore leads to a translation of the hydraulic piston 22, and thus a variation of the entire fluid volume communicating with the drive volume 60 for each pumping system.

The hydraulic piston 22 drives the pump 10 by means of a hydraulic system.

The hydraulic system extends here between the hydraulic piston 22 and the or each diaphragm 52.

The displacement of the hydraulic piston 22 then leads to a corresponding displacement of the diaphragm 52.

Thus, the movement of the hydraulic piston 22 drives the operation of the pump, more particularly here the alternating displacement of each diaphragm.

The entire hydraulic system here is filled with oil.

The hydraulic system here comprises the bore 30, the reception volume 62, and the drive volume 60.

Oil is, for example, supplied at the bore at as many points as there are pumping systems. Each point fluidly communicates with a corresponding reception volume 62.

The hydraulic system here comprises at least one, more particularly two, conduit portion(s) within the pump.

More particularly, the hydraulic system comprises a conduit portion per pumping system.

The or each conduit portion extends more particularly between the rod 22 of the piston and the or one of the diaphragms 52 of the pump 10.

Each conduit portion here comprises the reception volume 62 of the corresponding pumping system.

The pump assembly 10 comprises at least one, here two, air passage(s) 64, 66 arranged so as to allow thermal exchanges between the hydraulic system and the at least one passage 64, 66.

For example, the air passage is delimited in the body, here the pump body 61, further partially delimiting the hydraulic system, here the conduit portion.

Alternatively, the at least one air passage is made in a piece surrounding the pump body, said piece extending against the pump body.

The pump body is, for example, made of metal, more particularly aluminum.

If applicable, the piece delimiting the at least one air passage is, for example, also made of metal, more particularly aluminum.

The at least one air passage 64, 66 is able to be supplied with air by an air source 68.

The air source 68 is here a compressed air source, more particularly compressed air from a compressor.

This allows to control the air supplied to the air passage.

The compressor is, for example, able to compress ambient air.

The at least one air passage 64, 66 is fluidly connected, opposite the air source 68, to the air inlet of the motor.

The at least one air passage 64, 66 is directly delimited in the pump body.

The or each air passage 64, 66 comprises a respective air passage ring 70, 72 extending around the or one of the respective conduit portion, more particularly around the corresponding reception volume 62, more particularly over an entire circumference.

The or each ring 70, 72 extends around a central axis X, X′.

The radial distance between the or each ring 70, 72 and the conduit portion, here the reception volume 62, is strictly greater than 0.1 mm.

The radial distance is chosen so as to withstand the pressure exerted by the oil, for example at the maximum oil pressure within the hydraulics, for example here at 240 bar.

The radial distance is chosen so as to allow thermal exchanges between the or each ring 70, 72 and the conduit portion.

More particularly, the internal face of the ring cools toward the conduit portion, and the external face also cools the assembly, particularly the lower part of the pump.

The or each ring 70, 72 presents a translational symmetry along the central axis X, X′.

The or each ring 70, 72 presents an internal wall 74 and an external wall 76, the air circulating between the internal wall and the external wall.

The thickness of each ring, in other words, the distance between the internal wall 74 and the external wall 76, is chosen to avoid pressure losses, particularly relative to the inlets 78, 80 described below.

The internal wall and the external wall are, for example, here corrugated.

Here, the internal wall and the external wall are corrugated with grooves parallel to the central axis X, X′.

Alternatively, the internal wall and the external wall are corrugated with grooves perpendicular to the central axis X, X′.

The grooves are, for example, threads.

Thus, the or each ring 70, 72 defines a corrugated annular space.

This allows to increase the contact surface and thus promote heat exchange between the air in the air passage and the hydraulic fluid in the respective conduit, and thus the hydraulic system.

This also leads to the appearance of turbulence that also promotes heat exchange.

Alternatively, only the internal wall or the external wall is corrugated.

Alternatively, the internal wall and the external wall are not corrugated, the or each ring 70, 72 defining a conventional annular space.

The internal wall and the external wall are then, for example, provided with fins.

The fins promote thermal exchanges.

The or each ring 70, 72 presents an inlet 78, 80 and an outlet 82, 84.

For each ring 70, 72, the inlet 78, 80 and the outlet 82, 84 are, for example, diametrically opposed to each other relative to the central axis.

Alternatively, the inlet 78, 80 and the outlet 82, 84 form, for example, an angle between 90° and 180°.

This thus allows thermal exchanges to take place over the entire circumference of the ring.

Alternatively, the inlet 78, 80 and the outlet 82, 84 are not circumferentially offset.

For each ring 70, 72, the inlet 78, 80 and the outlet 82, 84 are, for example, offset according to a direction parallel to the central axis X, X′ of the ring, for example by at least two-thirds of the dimension of said ring according to said direction.

In FIGS. 1 to 3, each inlet 78, 80 is here arranged in one of the planes II, III, while the corresponding outlet 82, 84 is arranged in the other of the planes III, II.

This allows thermal exchanges to take place over most of the ring parallel to the central axis.

Furthermore, this allows the appearance of an air vortex in each ring 70, 72, around the reception volume 62, which promotes exchanges between the reception volume 62 and the ring.

The inlets 78, 80 of the rings 70, 72 are, for example, arranged on the same plane perpendicular to the central axis of each ring.

The outlets 80, 82 of the rings 70, 72 are, for example, arranged on the same plane perpendicular to the central axis of each ring.

To facilitate the understanding of the connections described with reference to FIGS. 4 and 5, the feature according to which the inlet 78, 80 and the outlet 82, 84 are offset in a direction parallel to the central axis X, X′ of the ring is not represented, all the inlets and outlets being here schematically represented.

In a first alternative, represented in FIG. 4, the inlet 78 of a first of the air passages is able to be connected to the air source 68, so that the air source 68 supplies the first of the air passages.

The outlet 82 of the first of the air passages is fluidly connected to the inlet 80 of the second of the air passages.

The outlet 84 of the second of the air passages is fluidly connected to the air inlet 18 of the motor.

In a second alternative, represented in FIG. 5, the inlets 78, 80 of the two air passages are able to be connected to the air source 68, so that the air source 68 supplies the air passages in parallel.

The air source 68 is, for example, connected to the inlets 78, 80 by means of a T piece.

The outlets 82, 84 of the air passages are connected to the air inlet 18 of the motor, for example by means of a T piece.

A method of using the pump assembly will now be described in general terms.

The motor is activated so that the pump, pumps the coating product.

This leads to heating of the hydraulic system, here oil.

The at least one air passage is supplied with air by the air source, here compressed air.

Thermal exchanges are made between the air in the at least one air passage and the hydraulic system.

Thus, the hydraulic system is cooled, while the air temperature increases.

Then, the motor is supplied with air from the at least one air passage.

The air supplying the motor has been heated, so that it allows to heat the motor and thus prevents frost formation.

The air supply pressure to the motor is proportional to, here equal to, the air supply pressure in the air passages.

The method of using the pump assembly according to the first alternative will now be described in more detail.

The motor is activated so that the pump, pumps the coating product.

This leads to heating of the hydraulic system, here oil.

The inlet 78 is supplied with air, here compressed air, by the air source 68. The air circulates in the first of the air passages, here more particularly in the ring, to the outlet 82.

By thermal exchange between the first of the air passages and the hydraulic system, here the corresponding conduit portion, more particularly the reception volume 62, the air temperature increases, while the hydraulic system is cooled, more particularly the corresponding pumping system.

The air is then supplied to the second of the air passages, by the inlet 80.

The air circulates in the second of the air passages, here more particularly in the ring, to the outlet 84.

By thermal exchange between the second of the air passages and the hydraulic system, here the corresponding conduit portion, more particularly the reception volume 62, the air temperature increases again, while the hydraulic system is cooled, more particularly at the corresponding pumping system.

Thus, the hydraulic system is cooled for each pumping system.

Finally, the motor is then supplied with air from the second air passage.

The air supplying the motor has been successively heated, so that it allows to heat the motor and thus prevents frost formation.

The method of using the pump assembly according to the second alternative will now be described in more detail.

The motor is activated so that the pump pumps the coating product.

This leads to heating of the hydraulic system, here oil.

The inlets 78, 80 are supplied with air, here compressed air, by the air source 68. The air circulates, in parallel, in each of the air passages, here more particularly in each ring, to the corresponding outlet 82, 84.

By thermal exchange between the corresponding air passage and the hydraulic system, the air temperature increases, while the hydraulic system is cooled.

Thus, the hydraulic system is cooled, in parallel, for each pumping system.

The motor is supplied with air from the air passages.

The air supplying the motor has been heated either by the first passage or by the second passage, so it allows to heat the motor and thus prevents frost formation.

Thus, the pump assembly according to the invention allows both cooling of the hydraulic system and heating of the motor.

Furthermore, in the invention, the cooling depends on the air supply pressure of the motor, which is directly related to the heating of the oil in the hydraulic system. Thus, the cooling is adapted to the possible heating of the oil.

For example, if the pump is supplied with low air pressure, for example one bar, and operates at a low flow rate, for example 20 cycles per minute, the oil would not heat much, as the compression of the oil is low and spaced over time. However, this also means that the air passages are supplied with low air pressure. Thus, the cooling will be less.

In contrast, if the pump is supplied with high air pressure, for example five bar, and operates at a high flow rate, for example 150 cycles per minute, then the oil is more stressed in compression and less spaced over time. The oil would then heat up faster and rise higher in temperature. However, the air passages being also supplied with high air pressure, the cooling will be greater, the thermal exchanges being more important at high pressure and speed.

Thus, in the pump according to the invention, the cooling is adapted to the use of the pump.

Similarly, at low air pressure and low flow rate, the motor presents, by default, less risk of frost than at high air pressure and high flow rate. However, in the invention, since the thermal exchanges are more important at high air pressure and high flow rate, the air injected into the motor at the air inlet 18 will be hotter at high air pressure and high flow rate, and will contribute more to heating the motor, to prevent frosting of the motor at high air pressure and high flow rate.

Thus, the cooling of the hydraulic system and the heating of the motor are adapted to the use of the pump.

1. A pump assembly for a coating fluid, the pump assembly comprising:
a hydraulic system that comprises at least one pumping system;
a motor that comprises an air inlet, wherein the motor is configured to drive the at least one pumping system of the hydraulic system; and
at least one air passage configured to allow thermal exchanges between the hydraulic system and the at least one air passage, wherein the at least one air passage is configured to be supplied with air by an air source, and wherein the at least one air passage is fluidly connected opposite the air source to the air inlet of the motor.

2. The pump assembly of claim 1, wherein the air source is compressed air from a compressor.

3. The pump assembly of claim 1, wherein the pump assembly is a diaphragm pump, and the hydraulic system is filled with oil and extends between a piston of the hydraulic system and at least one diaphragm of the diaphragm pump.

4. The pump assembly of claim 1, further comprising a pump body, wherein the at least one air passage is directly delimited in the pump body.

5. The pump assembly of claim 3, wherein the hydraulic system further comprises at least one conduit portion filled with oil, wherein the conduit portion extends between a piston of the hydraulic system and the at least one diaphragm of the diaphragm pump.

6. The pump assembly of claim 5, wherein the at least one air passage comprises a respective air passage ring extending around each conduit portion.

7. The pump assembly of claim 6, wherein each air passage ring comprises an internal wall and an external wall configured so that air circulates between the internal wall and the external wall, wherein one or both of the internal wall and the external wall is corrugated.

8. The pump assembly of claim 6, wherein each ring comprises an inlet and an outlet that are diametrically opposed to each other.

9. The pump assembly of claim 6, wherein each ring comprises an inlet and an outlet that are offset according to a direction parallel to a central axis of the ring.

10. The pump assembly of claim 1, wherein the at least one air passage is a first air passage and a second air passage and each such air passage comprises an inlet and an outlet, wherein the inlet of a first air passage is fluidly connected to the air source and the outlet of the first air passage fluidly connected to the inlet of the second air passage, and the outlet of the second air passage is fluidly connected to the air inlet of the motor.

11. The pump assembly of claim 1, wherein the at least one air passage is two air passages and each such air passage comprises an inlet and an outlet, wherein the inlets of the two air passages are fluidly connected to the air source so that the air source supplies the air passages, and the outlets of the air passages are fluidly connected to the air inlet of the motor.
